(19) United States
(12) Patent Application Publication
(10) Pub. No.: US 2007/0036158 A1
(43) Pub. Date: Feb. 15, 2007

(54) Media sink device and method for controlling the same

(75) Inventors: Kwang Hun-Kwon, Seoul (KR); Sang Hoon Cha, Seoul (KR)

Correspondence Address: BIRCH STEWART KOLASCH & BIRCH, PO BOX 747, FALLS CHURCH, VA, 22040-0747, US

(73) Assignee: LG Electronics Inc.

(21) Appl. No.: 11/502,548

(22) Filed: Aug. 11, 2006

(30) Foreign Application Priority Data
Aug. 11, 2005 (KR) 10-2005-0073591

(51) Int. Cl. H04L 12/56

(52) U.S. Cl. 370/389

(57) ABSTRACT

A Media sink device and a method for controlling the same are disclosed. A Media sink device for receiving media data from at least two media source devices includes: at least two interfaces for receiving the media data from the at least two media source devices; and a controller for determining a selected media source device, receiving a predetermined voltage signal having a predetermined voltage value from the interface connected to the determined media source device, outputting a high-level signal to a selected interface, and outputting a low-level signal to the remaining interface other than the selected interface, thereby controlling a connection of the at least two media source devices.

This application claims the benefit of Korean Patent Application No. 10-2005-0073591, filed on Aug. 11, 2005, which is hereby incorporated by reference as if fully set forth herein.

### BACKGROUND OF THE INVENTION

1. Field of the Invention

The present invention relates to a Media sink device and a method for controlling the same, and more particularly to a Media sink device including at least two media interface input terminals and a method for controlling the same.

2. Discussion of the Related Art

Generally, a media source device (e.g., a STB) for reproducing predetermined media data and processing the reproduced media data is connected to a Media sink device (e.g., a DTV) for receiving media data from the media source device and outputting the received media data to an external part via a predetermined interface cable. In this case, the media source device may be connected to the Media sink device via an interface cable (e.g., a DVI or a HDMI).

Recently, the higher the complexity of digital systems, the higher the number of HDMI (High-Definition Multimedia Interface) input terminals from among a variety of external input terminals of the digital systems.

The HDMI serves as a one-step upgraded interface of a conventional DVI (Digital Visual Interface). If the DVI is designed to transmit only digital video data, the HDMI serves as a single interface for transmitting the digital video data, digital audio data, and additional information.

A plurality of source devices are connected to the DTV system via the DVI interface and an additional audio interface. However, due to the increasing development of the HDMI acting as a new interface, most of source devices are rapidly being changed from the DVI system to the HDMI system.

FIG. 1 is a block diagram illustrating a conventional connection between a Media sink device equipped with a single HDMI input terminal (i.e., HDMIl) and a media source device.

Referring to FIG. 1, if the media source device 110 is connected to the Media sink device 100 via the HDMI cable according to a plug and play function, the media source device 110 periodically detects the presence or absence of a HPD signal generated from the Media sink device 100.

If a single interface is located between the Media sink device and the media source device, the voltage of 5V received via a connector is bypassed and the bypassed result is directly applied to the HPD.

With the increasing development of the HDMI technology, a variety of chips capable of supporting HDMI2 input terminals have recently been developed and come into the market by chip vendors. Due to the widespread use of the above-mentioned chips, DTV systems have recently been developed. Particularly, the DTV system increases the number of HDMI input terminals to at least two HDMI input terminals, such that it can appropriately cope with many more source devices.

FIG. 2 is a block diagram illustrating a conventional connection between a Media sink device equipped with two HDMI input terminals (i.e., HDMI2) and two media source devices.

Referring to FIG. 2, a single Media sink device is connected to a single media source device via an input terminal of +5V and an HPD output terminal.

In other words, each Media sink device is connected to each media source device independent of each other. Compared with the connection diagram of FIG. 1, the connection diagram of FIG. 2 increases the number of interfaces whereas it has the same Input/Output (I/O) control scheme as that of FIG. 1.

However, if the Media sink device capable of supporting the above-mentioned two HDMI input terminals is connected to two media source devices at the same time, only one media source device is enabled. In this case, the other media source device other than the enabled media source device may unexpectedly encounter faulty operations.

### SUMMARY OF THE INVENTION

Accordingly, the present invention is directed to a Media sink device and a method for controlling the same that substantially obviate one or more problems due to limitations and disadvantages of the related art.

An object of the present invention is to provide a Media sink device for preventing the occurrence of faulty operations of media source devices connected to the Media sink device including at least two external input terminals, and a method for controlling the Media sink device.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a Media sink device for receiving media data from at least two media source devices comprises: at least two interfaces for receiving the media data from the at least two media source devices; and a controller for determining a selected media source device, receiving a predetermined voltage signal having a predetermined voltage value from the interface connected to the determined media source device, outputting a high-level signal to a selected interface, and outputting a low-level signal to the remaining interface other than the selected interface, thereby controlling a connection of the at least two media source devices.

Preferably, the interface is a Digital Visual Interface (DVI).

Preferably, the interface is a High Definition Multimedia Interface (HDMI).

Preferably, the interface includes: a power-signal input unit for receiving the predetermined voltage signal; and a Hot Plug Detect (HPD) output unit for outputting a Hot Plug Detect (HPD) signal if the predetermined voltage signal is received in the power-signal input unit.

Preferably, the media sink device and the media source devices are interconnected via a High Definition Multimedia Interface (HDMI) cable.

Preferably, the high-level signal transmitted from the controller to the selected interface indicates a specific status in which the Media sink device is ready to receive the media data.

In another aspect of the present invention, there is provided a method for controlling a Media sink device receiving media data from at least two media source devices comprising the steps of: a) determining a media source device selected from among the at least two media source devices connected to the Media sink device; b) detecting an output power value of the determined media source device, and determining whether a predetermined power value is detected on the basis of the predetermined output power; and c) if the output power of the media source device has the predetermined power value, generating a high-level signal to operate a corresponding media source device, and generating a low-level signal not to operate the remaining media source devices other than the corresponding media source device.

Preferably, the media sink device outputs the low-level signal in an initial status.

Preferably, the high-level signal or the low-level signal is outputted via a Hot Plug Detect (HPD) signal pin.

Preferably, the method further comprises the step of: if the output power of the media source device does not have the predetermined power value, generating the low-level signal not to operate the corresponding media source device and the remaining media source devices other than the corresponding media source device.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a block diagram illustrating a conventional connection between a Media sink device equipped with a single HDMI input terminal (i.e., HDMI1) and a media source device;

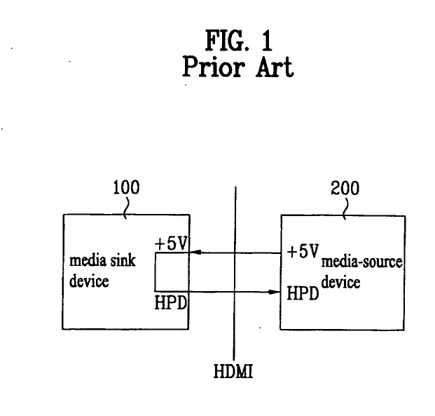

FIG. 2 is a block diagram illustrating a conventional connection between a Media sink device equipped with two HDMI input terminals (i.e., HDMI2) and two media source devices;

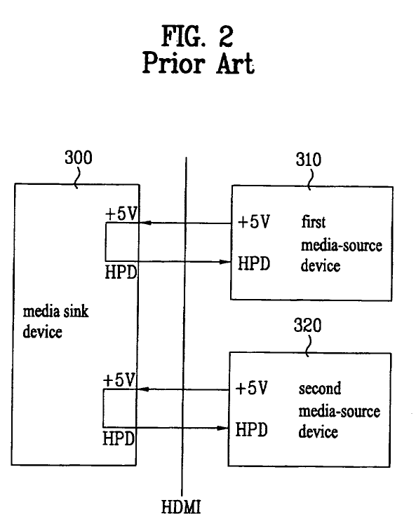

FIG. 3 is a conceptual diagram illustrating a connection between a Media sink device equipped with at least two interfaces and a media source device according to the present invention;

FIG. 4 is a block diagram illustrating exemplary assignment pins of a connector for connecting a Media sink device to media source devices according to the present invention;

FIG. 5 is a flow chart illustrating a method for controlling media source devices connected to a Media sink device including at least two interfaces according to the present invention; and

FIG. 6 is a flow chart illustrating a method for controlling HPD pins on the condition that a Media sink device including N HDMI input terminals is connected to media source devices according to the present invention.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

A Media sink device receives media data (e.g., multimedia contents) from a media source device, and displays the received media data on an external device. The media source device reproduces/processes the media data.

There are a variety of media source devices, for example, a set-top box (STB), a digital versatile disc (DVD)—player, a personal video recorder (PVR)—player, a digital video recorder (DVR), a personal TV receiver (PTR), a personal video station (PVS), and a hard disc recorder (HDR), etc. The media source device is connected to an interface of the Media sink device.

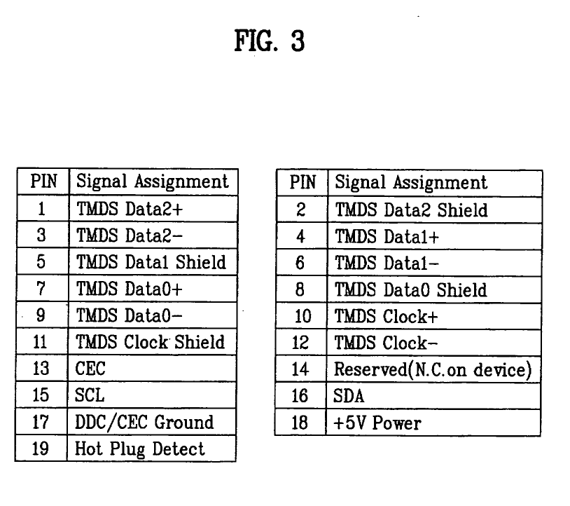

The present invention provides a Media sink device equipped with an interface connected to N media source devices. For the convenience of description, FIG. 3 shows the Media sink device including two external input terminals.

The interface of the Media sink device acts as a path for receiving media data (e.g., multimedia contents) from the media source device. The interface of the Media sink device may be connected to the media source device via the cable. There are a variety of interfaces, for example, a HDMI (High Definition Media Interface) and a DVI (Digital Visual Interface), etc. For the convenience of description, the present invention assumes that a representative example of the interface is the HDMI, however, it should be noted that the scope of the present invention is not limited to the above-mentioned example, and can also be applied to other examples as necessary.

FIG. 3 is a block diagram illustrating exemplary assignment pins of a connector for connecting a Media sink device to media source devices according to the present invention.

The interface or connector of the Media sink device is indicative of a path connected to the media source device. The assignment pins of the connector depicted in FIG. 3 are indicative of assignment pins of the HDMI.

A method for allowing the Media sink device to control the media source device on the condition that the Media sink device is connected to the media source device will hereinafter be described with reference to FIG. 3.

If the Media sink device is connected to the media source device, it detects a signal received from a power-pin of +5V, and transmits a HPD signal to the detected source device. An 18-th pin of the HDMI connector is indicative of the +5V power pin, and a 19-th pin of the HDMI connector is indicative of a HPD (Hot Plug Detect) pin.

The above-mentioned +5V power pin acts an input-mode pin for receiving the voltage from the media source device to the Media sink device via the Media sink device.

The above-mentioned HPD pin acts as a signal indicating that the Media sink device can receive the HDMI or DVI signal via an output-mode pin of the Media sink device. In this case, if the HPD signal is in a high level, this means that the Media sink device is able to receive the HDMI or DVI signal via the output-mode pin. Otherwise, if the HPD signal is in a low level, this means that the Media sink is unable to receive the HDMI or DVI signal via the output-mode pin.

All the media source devices (Sources) should assert the +5V power signal whenever the Source employs the DDC or TDMS signals. The voltage driven by the Source should be within the range from 4.8 Volts to 5.3 Volts. The Source should have +5V power signal over-current protection of no more than 0.5A. All the Sources should be able to supply a minimum of 55 mA to the +5V power pin.

The Media sink device (Sink) should not draw a current signal of more than 50 mA from the +5V power pin. When the Sink is powered on, it can draw a current signal of no more than 10 mA from the +5V power signal.

The Sink should assume that any voltage is within the range from 4.7 Volts to 5.3 Volts.

A cable assembly should be able to supply a minimum of 50 mA to the Sink via the +5V power pin, even when it is connected to a Source capable of providing a current signal of more than 55 mA. The +5V power signal returns to the DDC/CEC ground signal.

The high-level signal generated from the Media sink device to the HPD pin satisfies a voltage range from a minimum of 2.4V to a maximum of 5.3V. The low-level signal generated from the Media sink device to the HPD pin satisfies another voltage range from a minimum of 0V to a maximum of 0.4V.

If the Media sink device is connected to the media source device, the media source device detects the HPD signal generated from the Media sink device, such that it recognizes the presence of the Media sink device connected to the media source device itself.

The media source device recognizes detailed information of the Media sink device using an EDID signal generated from the Media sink device.

The media source device converts the media data into another data using the recognized information, such that the converted media data is appropriate for display environments of the Media sink device. The converted media data is transmitted to the Media sink device according to the TMDS scheme called a panel link.

The above-mentioned EDID signal includes a manufacturer ID indicating a manufacturing company, a manufacturing ID indicating a model number of a manufactured product, power-saving mode function information, and timing information, etc. Particularly, the above-mentioned EDID signal may also include audio format information of the Media sink device. The media source device performs parsing of the EDID, such that it can recognize audio format information of the Media sink device.

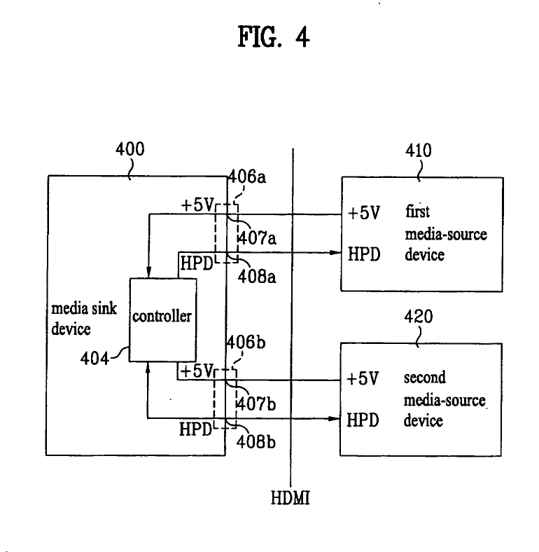

FIG. 4 is a conceptual diagram illustrating a connection between a Media sink device equipped with at least two interfaces and a media source device according to the present invention.

Referring to FIG. 4, if the media source devices 410 and 420 are connected to the Media sink device 400 via the HDMI cable according to a plug and play function, the media source devices 410 and 420 periodically detect the presence or absence of the HPD signal automatically received from the Media sink device 400.

The Media sink device 400 supports two HDMI input terminals (i.e., HDMI2) from among external input terminals. Therefore, the Media sink device 400 includes a first port 406a connected to a first media source device 410, a second port 406b connected to a second media source device 420, and a controller 404 for controlling a connection between the first media source device 410 and the second media source device 420.

The first port 406a and the second port 406b have unique port numbers and unique HPD numbers, respectively.

In other words, the first port 406a includes a first power pin 407a for receiving the voltage of +5V from the first media source device 410, and a first HPD pin 408a for generating the HPD signal. The second port 406b includes a second power pin 407b for receiving the voltage of +5V from the second media source device 420, and a second HPD pin 408b for generating the HPD signal.

Therefore, the Media sink device 400 determines the connection mode of the media source devices 410 and 420 using the port numbers, and applies a high signal to a specific HPD number corresponding to the connected media source device.

If the first media source device 410 is connected to the second media source device 420, the controller 404 prevents the occurrence of faulty operations of the media source devices 410 and 420 by controlling the HPD pins 408a and 408b.

In more detail, if the first media source device 410 is selected by a user, the controller 404 checks the power of the first power pin 407a. If the power of the first power pin 407a reaches the voltage of +5V, the controller 404 allows the first HPD pin 408a to be a high level, and allows the second HPD pin 408b to be a low level, such that the first media source device 410 is enabled by the high-level signal of the first HPD pin 408a, and the second media source device 420 is disabled by the low-level signal of the second HPD pin 408b.

If the second media source device 420 is selected by the user, the controller 404 checks the power of the second power pin 407b. If the power of the second power pin 407b reaches the voltage of +5V, the controller 404 allows the second HPD pin 408b to be a high level, and allows the first HPD pin 408a to be a low level, such that the second media source device 420 is enabled by the high-level signal of the second HPD pin 408b, and the first media source device 410 is disabled by the low-level signal of the first HPD pin 408a.

Provided that the Media sink device 400 equipped with two HDMI input terminals includes a first HDMI input terminal and a second HDMI input terminal, the first and second HDMI input terminals have unique port numbers and unique HPD numbers, and the Media sink device (e.g., a digital TV set) 400 is in any one of the remaining modes other than the HDMI modes (e.g., an antenna mode, and a video1 mode, etc.) regardless of current input signals, the first HPD pin 408a and the second HPD pin 408b are always in a low level irrespective of connection of the media source devices 410 and 410.

The Media sink device 400 further includes the controller 404 by hardware or software, such that it can prevent the occurrence of faulty operations of the media source devices 410 and 420 connected to the Media sink device 400 itself.

In more detail, if the Media sink device 400 controls the HPD of the models, each of which includes two HDMI input terminals, from among external input terminals of the DTV system, and is connected to source devices including digital interface output terminals, for example, media source devices (e.g., STB, DVD player, and AV receiver, etc.) equipped with HDMI or DVI output terminals, the Media sink device 400 considerably reduces the number of HDMI- or DVI-interface errors.

Although the above-mentioned preferred embodiment has disclosed the Media sink device including two HDMI input terminals, it should be noted that the above-mentioned preferred embodiment can also be applied to other examples in which the number of HDMI input terminals is N.

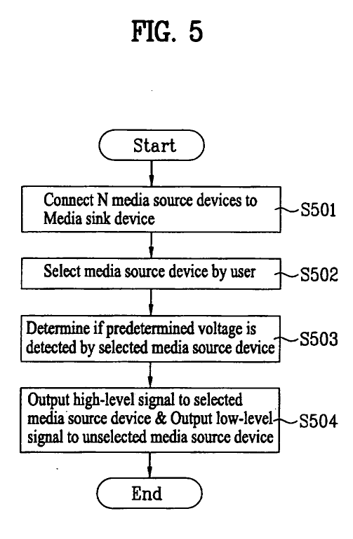

FIG. 5 is a flow chart illustrating a method for controlling media source devices connected to a Media sink device including at least two interfaces according to a preferred embodiment of the present invention.

A method for allowing the Media sink device to control the media source devices according to the present invention will hereinafter be described with reference to FIG. 5.

Referring to FIG. 5, N media source devices are connected to the Media sink device via an interface at step S501. A specific media source device is selected by the user at step S502. The user-selected media source device outputs a detected voltage signal to the Media sink device.

The Media sink device determines whether a predetermined voltage is detected by the selected media source device at step S503.

If the predetermined voltage is detected by the selected media source device at step S53, the Media sink device outputs a high-level signal to the selected media source device, and outputs a low-level signal to the other media source device (i.e., the unselected media source device) at step S504.

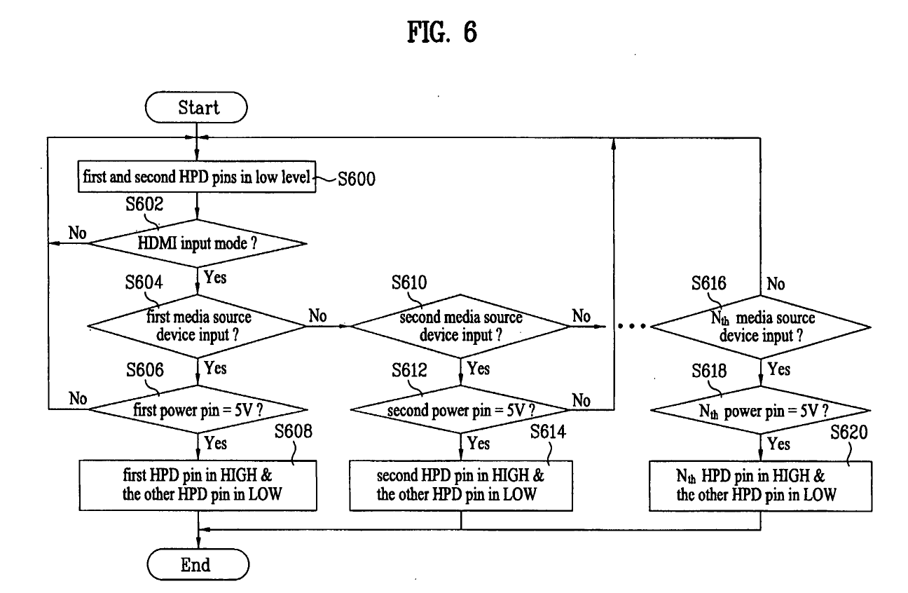

FIG. 6 is a flow chart illustrating a method for controlling HPD pins on the condition that a Media sink device including N HDMI input terminals is connected to media source devices according to the present invention.

Referring to FIG. 6, if the first HPD pin, the second HPD pin, and the N-th HPD pin are in a low level at step S600, the Media sink device determines whether a current mode is a HDMI mode at step S602.

If the current mode is the HDMI mode at step S602, the Media sink device determines whether a current status is an input status of the first media source device at step S604.

If any one of the remaining modes other than the HDMI modes (e.g., antenna mode, and video1 mode, etc.) is provided, the first and second HPD pins are always in a low level, irrespective of connection of the media source devices.

Under this situation, if a current mode reaches the HDMI mode, the Media sink device determines which one of the first and second media source devices has been selected.

If the current mode is determined to be a first media source device input mode at step S604, the Media sink device determines whether the first power pin has the voltage of +5V at step S606.

In more detail, the above-mentioned Media sink device recognizes the power received via the first power pin, and determines whether the recognized power is the voltage of +5V at step S606.

If the first power pin has the voltage of +5V at step S606, the Media sink device controls the first HPD pin to be in a high level, and controls the remaining HPD pins (i.e., the second HPD pin □ the N-th HDP pin) to be in a low level at step S608.

In other words, if the first power pin has the voltage of +5V, the above-mentioned Media sink device controls the first HPD pin to be in a high level so as to operate the first media source device, and maintains the unselected HPD pins at the low level so as to prevent the remaining media source devices (i.e., the second to N-th media source devices) from being operated.

If the voltage of +5V is not detected by the first power pin at step S606, the Media sink device maintains all the HPD pins at the low level.

If the first media source device input mode is not provided at step S604, and the second media source device input mode is provided at step S610, the Media sink device determines whether the second power pin has the voltage of +5V at step S612.

In more detail, if the user selects the second media source device, the Media sink device recognizes the power received via the second power pin, and determines whether the recognized power is the voltage of +5V at step S612.

If the second power pin has the voltage of +5V at step S612, the Media sink device controls the second HPD pin to be in a high level, and controls the unselected HPD pins to be in a low level at step S614.

In other words, if the second power pin has the voltage of +5V at step S612, the above-mentioned Media sink device determines that the second media source device has been selected, such that it operates the second media source device. Also, the above-mentioned Media sink device maintains the first media source device at the low level so as to prevent the first media source device from being operated.

As apparent from the above description, a Media sink device and a method for controlling the same according to the present invention can prevent the occurrence of faulty operations of media source devices connected to the Media sink device including at least two external input terminals.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A Media sink device for receiving media data from at least two media source devices comprising:
at least two interfaces for receiving the media data from the at least two media source devices; and
a controller for determining a selected media source device, receiving a predetermined voltage signal having a predetermined voltage value from the interface connected to the determined media source device, outputting a high-level signal to a selected interface, and outputting a low-level signal to the remaining interface other than the selected interface, thereby controlling a connection of the at least two media source devices.

2. The Media sink device according to claim 1, wherein the interface is a Digital Visual Interface (DVI).

3. The Media sink device according to claim 1, wherein the interface is a High Definition Multimedia Interface (HDMI)

4. The Media sink device according to claim 1, wherein the interface includes:
a power-signal input unit for receiving the predetermined voltage signal; and
a Hot Plug Detect (HPD) output unit for outputting a Hot Plug Detect (HPD) signal if the predetermined voltage signal is received in the power-signal input unit.

5. The Media sink device according to claim 1, wherein the media sink and the media source devices are interconnected via a High Definition Multimedia Interface (HDMI) cable.

6. The Media sink device according to claim 1, wherein the predetermined voltage value is +5V.

7. The Media sink device according to claim 1, wherein the high-level signal transmitted from the controller to the selected interface indicates a specific status in which the Media sink device is ready to receive the media data.

8. A method for controlling a Media sink device receiving media data from at least two media source devices comprising the steps of:
a) determining a media source device selected from among the at least two media source devices connected to the Media sink device;
b) detecting an output power value of the determined media source device, and determining whether a predetermined power value is detected on the basis of the predetermined output power; and
c) if the output power of the media source device has the predetermined power value, generating a high-level signal to operate a corresponding media source device, and generating a low-level signal not to operate the remaining media source devices other than the corresponding media source device.

9. The method according to claim 8, wherein the media sink device outputs the low-level signal in an initial status.

10. The method according to claim 8, wherein the predetermined power value is +5V.

11. The method according to claim 8, wherein each of the high-level signal and the low-level signal is outputted via a Hot Plug Detect (HPD) signal pin.

12. The method according to claim 8, further comprising the step of:
if the output power of the media source device does not have the predetermined power value, generating the low-level signal not to operate the corresponding media source device and the remaining media source devices other than the corresponding media source device.
